(19) United States
(12) Patent Application Publication
(10) Pub. No.: US 2024/0355137 A1
(43) Pub. Date: Oct. 24, 2024

(54) HARVESTING CIRCUIT INFORMATION FROM SCHEMATIC IMAGES

(71) Applicant: Siemens Industry Software Inc., Plano, FL (US)

(72) Inventors: Muhammad Askar, Sale (GB); Tony Eastwood, Penrhyndeudraeth (GB)

(73) Assignee: Siemens Industry Software Inc., Plano, TX (US)

(21) Appl. No.: 18/685,639

(22) PCT Filed: Aug. 31, 2021
(86) PCT No.: PCT/US2021/048332

§ 371 Date: Feb. 22, 2024

(51) Int. Cl. G06V 30/422; G06V 10/74

(52) U.S. Cl. CPC G06V 30/422; G06V 10/761

(57) ABSTRACT

A computing system to parse a schematic design illustrating a circuit design for an electronic system to identify text and enclosures representing circuit devices of the electronic system, The computing system can classify the text based on a proximity of the text to the enclosures in the schematic diagram, and match the text to the enclosures in the schematic diagram based on the classifications, which correlates the circuit devices represented by the enclosures to the text matched to the enclosures. The computing system can identify one of the circuit devices includes a connector having one or more pins, and correlate the text matched to the enclosure to at least one of the pins based on a relative alignment of the pins with the text. The computing system can generate an interactive technical file that includes the correlations of the circuit devices and pins to the text matched to the enclosures.

### TECHNICAL FIELD

This application is generally related to electronic design automation and, more specifically, to harvesting circuit information from schematic images.

### BACKGROUND

The design of electrical and electronic systems or interconnects, such as wiring harnesses for implementation into vehicles, aircraft, boats, appliances, or other systems with distributed electronics, can include many different design stages or phases at different levels of abstraction. For example, some of the design phases can include a requirements phase, a functional phase, a logical phase, a physical or wiring phase, a components phase, a form board or manufacturing phase, and a documentation phase.

The documentation phase can include developing sets of technical publication documents available for utilization in fault tracing, diagnostics, and maintenance through an interactive electronic technical publication (IETP) system. For complex products including electrical or electronic components, each electrical or electronic component can have separate schematic diagrams, which, in many cases, do not have sufficient detail to be utilized effectively in the IETP system. Most developers of the technical publications for use in the in the IETP system manually review the schematic diagrams and redraw them using commercial off-the-shelf software packages for subsequent utilization in the IETP system. This manual task is consuming and is error-prone.

### SUMMARY

This application discloses a computing system to parse a schematic design illustrating a circuit design for an electronic system to identify text and enclosures representing circuit devices of the electronic system, classify the text based on a proximity of the text to the enclosures in the schematic diagram, and match the text to the enclosures in the schematic diagram based on the classifications of the text, which correlates the circuit devices represented by the enclosures to the text matched to the enclosures. The computing system can identify one of the circuit devices includes a connector having one or more pins, and correlate the text matched to the enclosure representing the circuit device to at least one of the pins based on a relative alignment of the pins with the text in the schematic diagram. The computing system can generate an interactive technical file that includes the correlations of the circuit devices and pins to the text matched to the enclosures. Embodiments will be described in greater detail below.

### DESCRIPTION OF THE DRAWINGS

FIGS. 1 and 2 illustrate an example of a computer system of the type that may be used to implement various embodiments.

FIGS. 3A and 3B illustrate an example platform design system according to various embodiments.

FIG. 4 illustrates an example documentation design tool with a schematic conversion system according to various embodiments.

FIG. 5 illustrates a flow chart example of harvesting circuit information from schematic images according to various embodiments.

FIG. 6 illustrates an example schematic diagram having circuit information for harvesting according to various embodiments.

### DETAILED DESCRIPTION

### Illustrative Operating Environment

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads.

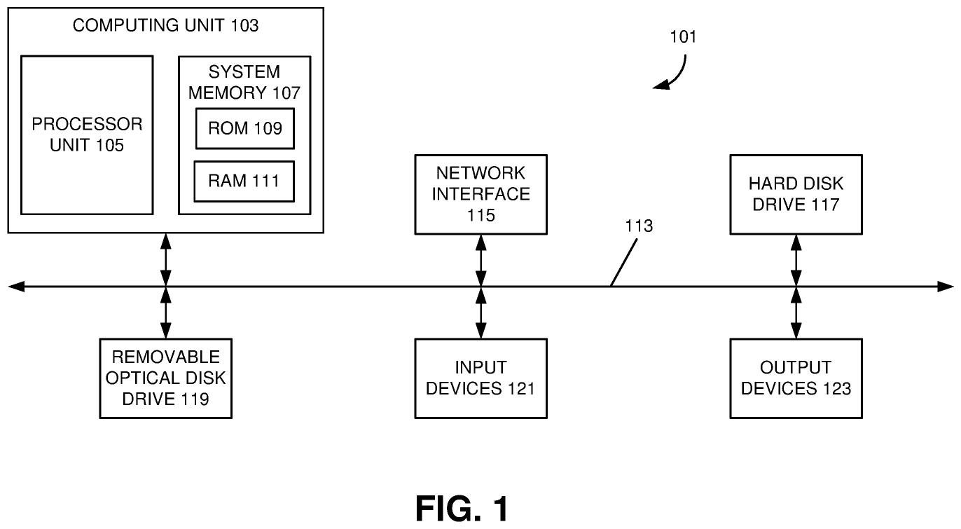

Various examples of the invention may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (LTSB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

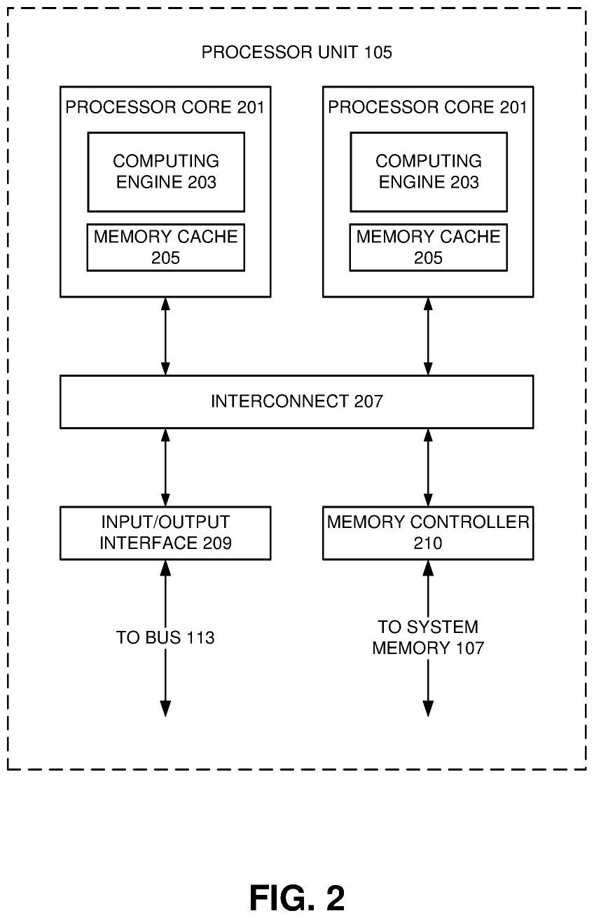

With some implementations of the invention, the processor unit 105 can have more than one processor core. Accordingly, FIG. 2 illustrates an example of a multi-core processor unit 105 that may be employed with various embodiments of the invention. As seen in this figure, the processor unit 105 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, California, the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 113. Similarly, the memory controller 211 controls the exchange of information between the processor unit 201 and the system memory 107. With some implementations of the invention, the processor units 201 may include additional components, such as a high-level cache memory accessible shared by the processor cores 201.

It also should be appreciated that the description of the computer network illustrated in FIG. 1 and FIG. 2 is provided as an example only, and it not intended to suggest any limitation as to the scope of use or functionality of alternate embodiments of the invention.

### Illustrative Platform Design System

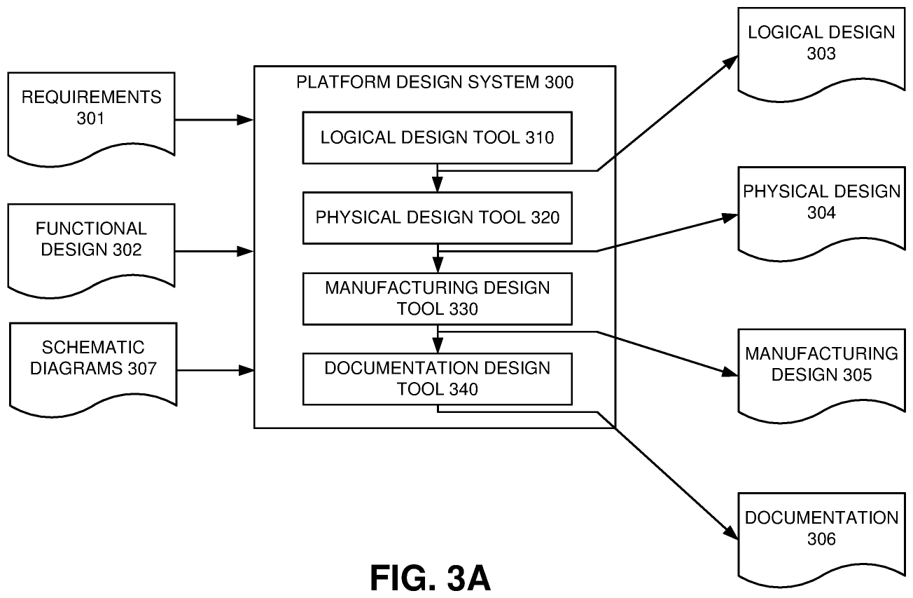

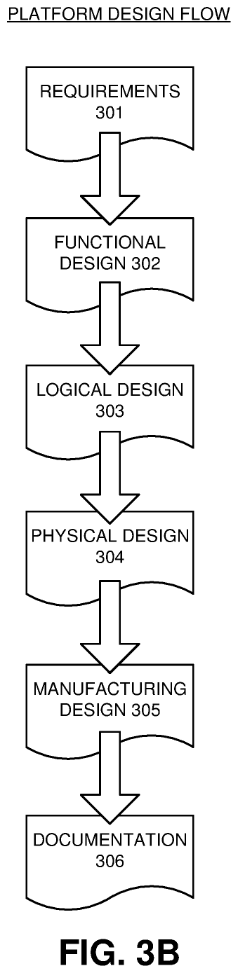

FIGS. 3A and 3B illustrate an example platform design system 300 according to various embodiments. Referring to FIGS. 3A and 3B, the platform design system 300 can include a set of one or more tools to develop at least a portion of an electronic system, such as a wiring harness. The development of the electronic system can be performed utilizing a platform design flow that includes multiple design stages, each representing the electronic system at a different level of abstraction.

The platform design flow can initially describe the electronic system as a set of requirements 301, for example, aspects, objectives, high-level operations, or the like, for the electronic system. The requirements 301 can be converted into a functional design 302, which can functionally describe the electronic system. The platform design flow continues by generating a logical design 303 for the electronic system. The logical design 303 can describe the connectivity and devices capable of implementing the functionality of the electronic system, for example, specified as a netlist or the like. The platform design flow can then include a physical design 304 that, in a wiring harness example, can describe the wires and components to physically implement the logical design 303. The platform design flow can then include a manufacturing design 305 that, in a wiring harness example, can describe specific harness components, such as mechanical structures, connectors, wire splices, or the like, as well as manufacturing aids, such as form boards, manufacturing tools, or the like. The platform design flow can include documentation 306 to describe manufacturing instructions, service or diagnostic information, decommissioning information, or the like, for the electronic system.

The platform design system 300 can include a logical design tool 310 to generate a logical design 303 for the electronic system, for example, based at least in part on the requirements 301 and the functional design 302 for the electronic system. In some embodiments, the logical design 303 can be a netlist for the electronic system, which can describe the connectivity and devices capable of implementing the functionality of the electronic system. The logical design tool 310 can receive the requirements 301 and the functional design 302 from a device external to the platform design system 300 or, in some embodiments, the platform design system 300 can include other tools (not shown) that can build or generate the requirements 301 and the functional design 302 for the electronic system.

The platform design system 300 can include a physical design tool 320 to generate a physical design 304 based, at least in part, on the logical design 303. The physical design 304, in a wiring harness example, can describe the wires and components to physically implement the logical design 303.

The platform design system 300 can include a manufacturing design tool 330 to generate a manufacturing design 305 based, at least in part, on the physical design 304. The manufacturing design 305, in the wiring harness example, can describe specific harness components, such as mechanical structures, connectors, wire splices, or the like, as well as manufacturing aids, such as form boards, manufacturing tools, or the like.

The platform design system 300 can include a documentation design tool 340 to generate documentation 306 based, at least in part, on the manufacturing design 305. In some embodiments, the documentation design tool 340 can receive one or more schematic diagrams 307 that describe electrical or electronic components as circuit diagrams, which the documentation design tool 340 can convert into an interactive technical file that can utilized as the documentation 306. The documentation 306, in the wiring harness example, can describe manufacturing instructions, service or diagnostic information, decommissioning information, or the like, for the electronic system. In some embodiments, the documentation design tool 340 can present the documentation 306 including the interactive technical file via an interactive electronic technical publication (IETP), which can provide support for fault fixing diagnostics, and maintenance of the electronic system. Embodiments of the documentation design tool 340 will be described below in greater detail.

Harvesting Circuit Information from Schematic Images

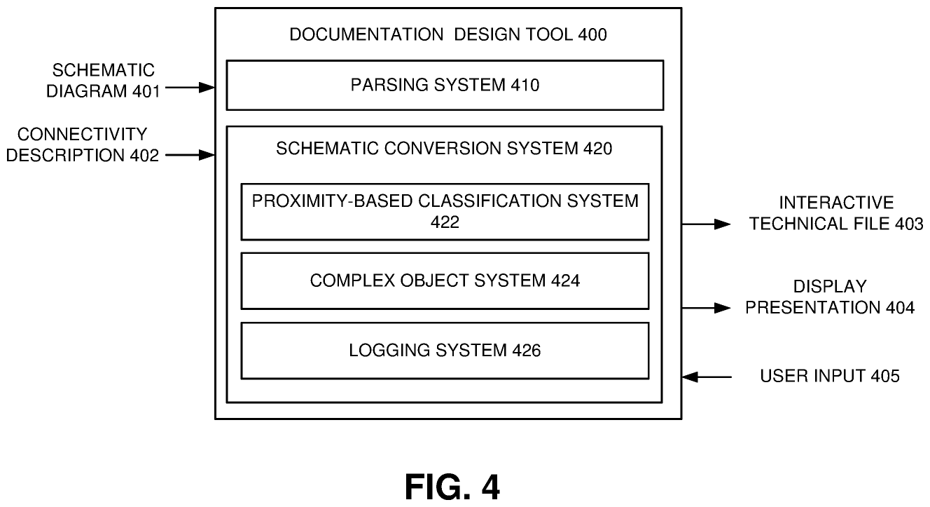

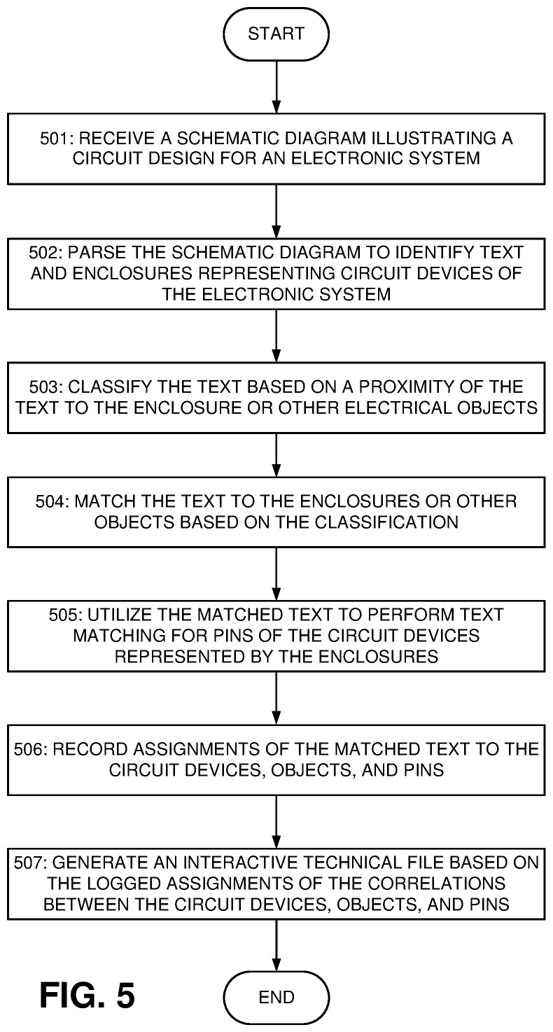

FIG. 4 illustrates an example documentation design tool 400 with a schematic conversion system 420 according to various embodiments. FIG. 5 illustrates a flow chart example of harvesting circuit information from schematic images according to various embodiments. Referring to FIGS. 4 and 5, the documentation design tool 400, in a block 501 of FIG. 5, can receive a schematic diagram 401 that graphically describes an electronic system utilizing circuit diagrams. The schematic diagram 401 can include one or more a vector-formatted images, such as computer graphics metafile (CGM) format, a portable document format (PDF), 3D extensible markup language (XML), Autosar XML (ARXML), vector (.vec) format, cable (.kbl) format, or the like. In some embodiments, the schematic diagram 401 can include hotspots, which can define a group of graphics in the schematic diagram 401 as being correlated together.

The documentation design tool 400 also can receive a connectivity description 402 describing the abstract electrical connectivity of the electronic system represented in the schematic diagram 401. In some embodiments, connectivity description 402 can identify the circuit devices or components within the electronic system and identify how they connect with each other, which can be specified in a list-type file, such as in a comma separate values (.csv) format.

The documentation design tool 400 can harvest circuit device information and connectivity information from the schematic diagram 401 based, at least in part, on the connectivity description 402, and generate an interactive technical file 403, for example, in a scalable vector graphics (SVG) format, which can be presented in a browser interface of an interactive electronic technical publication (IETP), such as Capital Smart Client Suite. The interactive technical file 403 can include the circuit device information from the schematic diagram 401, which has been further populated with information that links the circuit device information based on the harvested connectivity.

The documentation design tool 400 can include a parsing system 410 that, in a block 502 of FIG. 5, can parse the schematic diagram 401 to identify plain text, enclosures, wire lines, hotspots, or the like, in the image(s) of the schematic diagram 401. In some embodiments, the parsing system 410 also can determine a relative locations the plain text, enclosures, lines, hotspots, or the like in the schematic diagram 401. For example, the parsing system 410, while parsing the schematic diagrams 401, can determine when locations of the plain text fall within an enclosure or hotspot, outside of the enclosures or hotspots, or in an alignment with wire lines. The parsing system 410 also can determine an alignment for the plain text relative to the enclosures, wires lines, hotspots, or the like, in the schematic diagram 401.

Since certain manufacturers or producers of schematic diagrams can include plain text labels for circuit devices in predetermined locations, such as below the outside of the enclosure corresponding to those circuit devices, in some embodiments, the parsing system 410 can parse the schematic diagram 401 to identify a manufacturer or producer associated with the schematic diagram 401. The parsing system 410 can determine the drafting style associated with the schematic diagram 401, for example, based on the identified manufacturer or producer.

The schematic conversion system 420 can include a proximity-based classification system 422 that, in a block 503, can determine proximities of the plain text to enclosures, wire lines, hotspots, or the like. The proximity-based classification system 422 can utilize the relative locations the plain text, enclosures, wire lines, hotspots, or the like, as parsed from the schematic diagram 401 to determine the proximities of the plain text. In some embodiments, the proximity-based classification system 422 also can order the plain text based on these determined proximities, which can allow for a subsequent classification of the plain text.

The proximity-based classification system 422 can classify the plain text based on the proximity of the plain text to an enclosure or hotspot, based on the drafting style for the schematic diagram 401, and/or based on the connectivity description 402. In some embodiments, the plain text can be classified as enclosed text when the plain text falls within an enclosure, as proximate text when the plain text falls outside of an enclosure in a location corresponding to a label for the enclosure based on the drafting style, or as alignment text when the text has an alignment corresponding to a wire line and falls near a connection described by the connectivity description 402.

The proximity-based classification system 422, in a block 504 in FIG. 5, can match the plain text in the schematic diagram 401 to the enclosures, hotspots, and wire lines in the schematic diagram 401 based on the classification. The proximity-based classification system 422 can correlate the plain text to the electrical objects associated with the enclosures, hotspots, and wire lines matched to the plain text. For example, when the proximity-based classification system 422 matches plain text to a particular enclosure in the schematic diagram 401, the proximity-based classification system 422 can correlate that plain text to a circuit device corresponding to that enclosure, which can link the plain text to the circuit device.

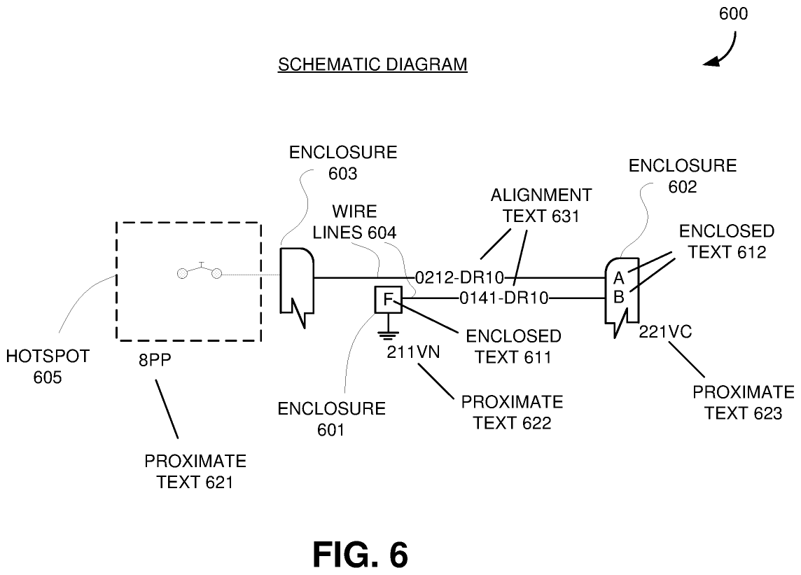

The proximity-based classification system 422, in some embodiments, can analyze the plain text matching to further refine the match. For example, when the plain text has been determined to match an enclosure corresponding to a circuit device having at least one pin, the proximity-based classification system 422, in a block 505 of FIG. 5, can perform a text matching operation to match the plain text to a particular pin in the circuit device corresponding to the enclosure. In some embodiments, the proximity-based classification system 422 can identify the pins and corresponding electrical connectivity for the circuit device utilizing the connectivity description 402 and then correlate the plain text correlated to the circuit device to at least one of the pins, for example, based on an alignment of the plain text to the connector associated with the electrical connectivity. The proximity-based classification system 422 can correlate the plain text to the matched connector of the circuit device, the pin of the connector, and the signal associated with the electrical connectivity through the pin. Embodiments of the text matching and text classification will be described below in greater detail with reference to FIG. 6.

FIG. 6 illustrates an example schematic diagram 600 having circuit information for harvesting according to various embodiments. Referring to FIG. 6, the schematic diagram 600 can include circuit information represented by enclosures 601-603 corresponding to circuit devices, wire lines 604 corresponding to trace wires in an electronic system, and circuitry corresponding to a hotspot 605. The hotspot 605 can correspond to an area of the schematic diagram 600 corresponding to a group of graphic images.

The schematic diagram 600 also can include text associated to the enclosures 601-603, the wire lines 604, and the hotspot 605. A schematic conversion system can identify the text, for example, after having been parsed from the schematic diagram 600, and correlate the text to the circuit information. In some embodiments, the schematic conversion system can identify text having been encapsulated within one of the enclosures 601-603 and correlate that enclosed text 611 and 612 to the corresponding circuit devices associated with the enclosures 601-603. For example, since the enclosure 601 surrounds enclosed text 611 and the enclosure 602 surrounds enclosed text 612, the schematic conversion system can correlate the circuit devices associated with enclosures 601 and 602 with the enclosed text 612.

Some of the text in the schematic diagram 600 may not be included within an enclosure 601-603 or a hotspot 605, so the schematic conversion system can determine the proximity of the text to the enclosures 601-603 and the hot spot 605. When text in the schematic diagram 600 has a proximity to one of the enclosures 601-603 or the hot spot 605, the schematic conversion system can correlate the circuit devices associated with the enclosures 601-603 and the hot spot 605 with the correspondingly proximate text 621-623. For example, since the proximate text 621 lies adjacent to the hotspot 605, the proximate text 622 lies adjacent to the enclosure 601, and the proximate text 623 lies adjacent to the enclosure 602, the schematic conversion system can correlate the circuit devices associated with the hotspot 605 and enclosures 601 and 602 with the proximate text 621-623, respectively.

Some of the text in the schematic diagram 600 may not be included within or proximate to an enclosure 601-603 or a hotspot 605, so the schematic conversion system can determine an alignment of the text within the schematic diagram 600. When text in the schematic diagram 600 has an alignment that corresponds to an alignment of other represented objects in the schematic diagram 600, the schematic conversion system can correlate the text with those similarly aligned objects. For example, the alignment text 631 can have a horizontal alignment consistent with the horizontal orientation of the wire lines 604, which can allow the schematic conversion system to correlate the alignment text 631 to the wire lines 604.

Once text has been correlated to one or more circuit devices or objects represented in the schematic diagram 600, the schematic conversion system can attempt to perform a further correlation based on the connectivity of the objects or circuit devices, for example, correlating pins in a circuit device to signals along wire lines 604. In this example, when the schematic conversion system determines the circuit device corresponding to enclosure 602 has two pins—A and B—which correlate to the wire lines 604, the schematic conversion system can correlate the pins of the enclosure 602 to the enclosed text 612, the wire lines 604, and the alignment text 631 previously correlated to the wire lines 604.

Referring back to FIGS. 4 and 5, the schematic conversion system 420 can include a complex object system 424 to identify when objects, such as electrical connectors of circuit devices, in the schematic diagram 401 have been represented multiple times. In some embodiments, the complex object system 424 can determine when the schematic diagram 401 includes multiple instances of the same plain text or when the same plain text has been correlated multiple times at different locations of the schematic diagram 401, and utilize the determination to group the multiple instances of the plain text together. The schematic conversion system 420 can generate the interactive technical file 403 to include a single instance of the object based on the grouping of the multiple instances of the plain text.

The complex object system 424 can analyze the schematic diagram 401 to identify complex circuit devices, such as multicore cable devices. In some embodiments, the complex object system 424 can detect a presence of a multicore cable device graphics in the schematic diagram 401 based on drafting style associated with the schematic diagram 401 and possibly a vertical separation between wire lines associated with the multicore cable device graphics. The complex object system 424 can generate a hotspot associated with the detected multicore cable device and, in some embodiments, generate a hotspot for wires within a single multicore cable device. The generated hotspots can be included in the interactive technical file 403, which can annunciate the presence of a multicore cable device or of specific wiring associated with the multicore cable device.

The schematic conversion system 420 can include a logging system 426, in a block 506 of FIG. 5, can record the assignments of the plain text and connectivity to the objects in the schematic diagram 401. For example, each match of plain text to an enclosure or pin can prompt the logging system 426 to generate an assignment of the plain text to a circuit device in the schematic diagram 401. The logging system 426 can effectuate the grouping of the multiple instances of an object in the schematic diagram 401 by recording the instance a single time. The logging system 426 also can record the generation of hotspots associated with the multicore cable devices. In some embodiments, the logging system 426 can identify plain text or object that the schematic conversion system 420 did not match or weakly matched and label those plain text or objects as ambiguous or doubtful.

The schematic conversion system 420, in a block 507 of FIG. 5, can generate the interactive technical file 403 based on the logged records. The schematic conversion system 420 can generate a display presentation 404 capable of displaying the interactive technical file 403 associated with the circuit information harvested from the schematic diagram 401. The interactive technical file 403 can include one or more links, that when selected based on user input 405, can prompt presentation of correlated objects or text. For example, when a technician selects a link to a particular connector of a circuit device in the presentation of the interactive technical file 403, a listing of the pins associated with the connector, their text labels, and their connectivity can be displayed.

The schematic conversion system 420 can receive user input 405 based, at least in part, on the display presentation 404, and modify the circuit information harvested from the schematic diagram 401 based on the user input 405. For example, when the logging system 426 indicated identified text or objects whose were unmatched or had a match deemed ambiguous or doubtful, and the display presentation 404 can highlight them for manual review and population. The schematic conversion system 420 can populate or modify the interactive technical file 403 in response to the user input 405 associated with the display presentation 404.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in a computer-readable memory device. The memory device may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory device may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory devices may be “read only” by design (ROM) by virtue of permission settings, or not. Other examples of memory devices may include, but may not be limited to, WORM, EPROM, EEPROM, FLASH, NVRAM, OTP, or the like, which may be implemented in solid state semiconductor devices. Other memory devices may comprise moving parts, such as a known rotating disk drive. All such memory devices may be “machine-readable” and may be readable by a processing device.

Operating instructions or commands may be implemented or embodied in tangible forms of stored computer software (also known as “computer program” or “code”). Programs, or code, may be stored in a digital memory device and may be read by the processing device. “Computer-readable storage medium” (or alternatively, “machine-readable storage medium”) may include all of the foregoing types of computer-readable memory devices, as well as new technologies of the future, as long as the memory devices may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to computing processes, it should be appreciated that various examples of the invention may be implemented using any desired combination of computing processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
parsing, by a computing system, a schematic design illustrating a circuit design for an electronic system to identify text and enclosures representing circuit devices of the electronic system;
classifying, by the computing system, the text based on a proximity of the text to the enclosures in the schematic diagram;
matching, by the computing system, the text to the enclosures in the schematic diagram based, at least in part, on the classifications of the text, which correlates the circuit devices represented by the enclosures to the text matched to the enclosures;
generating, by the computing system, an interactive technical file that includes the correlations of the circuit devices to the text matched to the enclosures.

2. The method of claim 1, further comprising:
identifying, by the computing system, one of the circuit devices includes a connector having one or more pins; and
correlating, by the computing system, the text matched to the enclosure representing the circuit device to at least one of the pins based on a relative alignment of the pins with the text in the schematic diagram.

3. The method of claim 1, wherein the text is classified as included within one of the enclosures, outside of the enclosures, or in alignment with one or more wire lines in the schematic diagram.

4. The method of claim 3, further comprising matching, by the computing system, the text to one of the wire lines in the schematic diagram based, at least in part, on the classification that indicates the text is in alignment with the one or more wire lines and a proximity of the text to the wire lines, wherein the interactive technical file includes a correlations of the wire line to the text.

5. The method of claim 1, further comprising identifying, by the computing system, components and their connectivity from a connectivity description of the electronic system associated with the schematic diagram, wherein matching the text to the enclosures in the schematic diagram is based, at least in part, on the classifications of the text and the components and their connectivity from the connectivity description.

6. The method of claim 1, further comprising identifying, by the computing system, a drafting style associated with a manufacturer of the schematic diagram, wherein the matching the text to the enclosures in the schematic diagram based, at least in part, on the classifications of the text.

7. The method of claim 1, wherein the schematic diagram is in a computer graphics metafile (CGM) format and the interactive technical file is a scalable vector graphics (SVG) format.

8. A system comprising:
a memory device configured to store machine-readable instructions; and
a computing system including one or more processing devices, in response to executing the machine-readable instructions, configured to:
parse a schematic design illustrating a circuit design for an electronic system to identify text and enclosures representing circuit devices of the electronic system;
classify the text based on a proximity of the text to the enclosures in the schematic diagram;
match the text to the enclosures in the schematic diagram based, at least in part, on the classifications of the text, which correlates the circuit devices represented by the enclosures to the text matched to the enclosures;
generate an interactive technical file that includes the correlations of the circuit devices to the text matched to the enclosures.

9. The system of claim 8, wherein the one or more processing devices, in response to executing the machine-readable instructions, are configured to:
identify one of the circuit devices includes a connector having one or more pins; and
correlate the text matched to the enclosure representing the circuit device to at least one of the pins based on a relative alignment of the pins with the text in the schematic diagram.

10. The system of claim 8, wherein the text is classified as included within one of the enclosures, outside of the enclosures, or in alignment with one or more wire lines in the schematic diagram.

11. The system of claim 10, wherein the one or more processing devices, in response to executing the machine-readable instructions, are configured to match the text to one of the wire lines in the schematic diagram based, at least in part, on the classification that indicates the text is in alignment with the one or more wire lines and a proximity of the text to the wire lines, wherein the interactive technical file includes a correlations of the wire line to the text.

12. The system of claim 8, wherein the one or more processing devices, in response to executing the machine-readable instructions, are configured to identify components and their connectivity from a connectivity description of the electronic system associated with the schematic diagram, wherein matching the text to the enclosures in the schematic diagram is based, at least in part, on the classifications of the text and the components and their connectivity from the connectivity description.

13. The system of claim 8, wherein the one or more processing devices, in response to executing the machine-readable instructions, are configured to identify a drafting style associated with a manufacturer of the schematic diagram, wherein the matching the text to the enclosures in the schematic diagram based, at least in part, on the classifications of the text.

14. An apparatus including a memory device storing instructions configured to cause one or more processing devices to perform operations comprising:
parsing a schematic design illustrating a circuit design for an electronic system to identify text and enclosures representing circuit devices of the electronic system;
classifying the text based on a proximity of the text to the enclosures in the schematic diagram;
matching the text to the enclosures in the schematic diagram based, at least in part, on the classifications of the text, which correlates the circuit devices represented by the enclosures to the text matched to the enclosures;
generating an interactive technical file that includes the correlations of the circuit devices to the text matched to the enclosures.

15. The apparatus of claim 14, wherein the instructions are configured to cause one or more processing devices to perform operations further comprising:
identifying one of the circuit devices includes a connector having one or more pins; and
correlating the text matched to the enclosure representing the circuit device to at least one of the pins based on a relative alignment of the pins with the text in the schematic diagram.

16. The apparatus of claim 14, wherein the text is classified as included within one of the enclosures, outside of the enclosures, or in alignment with one or more wire lines in the schematic diagram.

17. The apparatus of claim 16, wherein the instructions are configured to cause one or more processing devices to perform operations further comprising matching the text to one of the wire lines in the schematic diagram based, at least in part, on the classification that indicates the text is in alignment with the one or more wire lines and a proximity of the text to the wire lines, wherein the interactive technical file includes a correlations of the wire line to the text.

18. The apparatus of claim 14, wherein the instructions are configured to cause one or more processing devices to perform operations further comprising identifying components and their connectivity from a connectivity description of the electronic system associated with the schematic diagram, wherein matching the text to the enclosures in the schematic diagram is based, at least in part, on the classifications of the text and the components and their connectivity from the connectivity description.

19. The apparatus of claim 14, wherein the instructions are configured to cause one or more processing devices to perform operations further comprising identifying a drafting style associated with a manufacturer of the schematic diagram, wherein the matching the text to the enclosures in the schematic diagram based, at least in part, on the classifications of the text.

20. The apparatus of claim 14, wherein the schematic diagram is in a computer graphics metafile (CGM) format and the interactive technical file is a scalable vector graphics (SVG) format.
